(19) United States
(12) Patent Application Publication
(10) Pub. No.: US 2026/0367284 A1
(43) Pub. Date: Nov. 19, 2026

(54) Optical Member, Cover Window, And Electronic Apparatus Including The Same

(71) Applicant: Samsung Display Co., Ltd., Yongin-si (KR)

(72) Inventors: Hyun-Hyang Kim, Yongin-si (KR); Juyoung Yoon, Yongin-si (KR); Dahye Kim, Yongin-si (KR); Mansoo Kim, Yongin-si (KR); Junghyun Kim, Yongin-si (KR); Hyeonmi Lee, Yongin-si (KR)

(73) Assignee: Samsung Display Co., Ltd., Yongin-si (KR)

(21) Appl. No.: 19/653,358

(22) Filed: Apr. 21, 2026

(30) Foreign Application Priority Data
May 13, 2025 (KR) 10-2025-0062171

(51) Int. Cl. G02B 1/115; G02B 1/18; H04M 1/02

(52) U.S. Cl. CPC G02B 1/115; G02B 1/18; H04M 1/0266

(57) ABSTRACT

Provided are an optical member according to an aspect and a cover window including the same, which include a plurality of stacked units each including a high-refractive layer and a low-refractive layer disposed directly on the high-refractive layer and having a refractive index at least about 0.3 lower than that of the high-refractive layer. The high-refractive layer includes a composite material including Ge, and a content of Ge in the composite material is about 10 at % to about 50 at %.

### CROSS-REFERENCE TO RELATED APPLICATIONS

This U.S. non-provisional patent application claims priority under 35 U.S.C. § 119 to Korean Patent Application No. 10-2025-0062171, filed on May 13, 2025, the entire contents of which are incorporated herein by reference.

### BACKGROUND

The present disclosure herein relates to an optical member, a cover window, and an electronic apparatus, and more particularly, to an optical member in which a high-refractive layer and a low-refractive layer are stacked in turn, and a cover window including such an optical member, and an electronic apparatus including the cover window.

A multimedia electronic apparatus, such as televisions, mobile phones, tablets, navigation systems, and game consoles, displays an image to a user through a display surface, and may provide a touch-based input method by which a user may intuitively or conveniently input information or command.

The electronic apparatus may include a display module generating an image and a cover window for protecting the display module. The cover window should be provided as a component maintaining excellent optical properties and reliability in consideration of usage environment, and thus it is needed to develop an optical member having excellent durability and optical properties, a cover window to which the same is applied, and the like.

### SUMMARY

The present disclosure provides an optical member that simultaneously has excellent strength properties and low reflectance properties, and a cover window including the same.

The present disclosure also provides an electronic apparatus with excellent display quality by including a display module, a cover window disposed on the display module and having mechanical properties with high-hardness and low reflectance properties.

An aspect of the present disclosure provides an optical member including a plurality of stacked units which each include a high-refractive layer and a low-refractive layer directly disposed on the high-refractive layer and having a refractive index at least about 0.3 lower than that of the high-refractive layer, the high-refractive layer includes a composite material including Ge, and a content of the Ge in the composite material is about 10 at % to about 50 at %.

In an aspect, the high-refractive layer may include at least one among Ge₃N₄, an Al—Ge—N composite material, and an Al—Ge—O—N composite material.

In an aspect, the low-refractive layer may include at least one among SiO₂, SiON, and SiCₓO_{y}N_{z}.

In an aspect, all the high-refractive layers in the plurality of stacked units may include an Al—Ge—N composite material, and all the low-refractive layers in the plurality of stacked units may include a SiCₓO_{y}N_{z} composite material.

In an aspect, the high-refractive layer may have a refractive index of about 1.90 to about 2.30 at about 550 nm, and the low-refractive layer may have a refractive index of about 1.40 to about 1.60 at about 550 nm.

In an aspect, a base low-refractive layer disposed below a lowest stacked unit among the plurality of stacked units may be further included, and the base low-refractive layer may include at least one among SiO₂, SiON, and SiCₓO_{y}N_{z}.

In an aspect, the stacked units may include first to sixth stacked units, sequentially stacked in a thickness direction, a base low-refractive layer disposed below the first stacked unit may be further included, the high-refractive layer included in each of the first to sixth stacked units may include an Al—Ge—N composite material, the low-refractive layers in the first to sixth stacked units and the base low-refractive layer may each independently include SiO₂ or SiCₓO_{y}N_{z}, and at least one among the low-refractive layers in the first to sixth stacked units may include SiCₓO_{y}N_{z}.

In an aspect, an anti-fingerprint layer, disposed directly on an uppermost stacked unit among the stacked units and having a thickness of about 10 nm to about 30 nm may be further included.

In an aspect of the present disclosure, a cover window including a base substrate, and an optical member disposed on the base substrate and including a plurality of stacked units, the stacked units each include a high-refractive layer, and a low-refractive layer disposed directly on the high-refractive layer and having a refractive index at least about 0.3 lower than that of the high-refractive layer, and the high-refractive layer includes a composite material including Ge, and a content of Ge in the composite material is about 10 at % to about 50 at %.

In an aspect, the high-refractive layer may include at least one among Ge₃N₄, an Al—Ge—N composite material, and an Al—Ge—O—N composite material, and the low-refractive layer may include at least one among SiO₂, SiON, and SiCₓO_{y}N_{z}.

In an aspect, the stacked units may include first to sixth stacked units, sequentially stacked in a thickness direction, the optical member may further include a base low-refractive layer directly disposed between the base substrate and the first stacked unit, the high-refractive layer included in each of the first to sixth stacked units may include an Al—Ge—N composite material, the low-refractive layers in the first to sixth stacked units and the base low-refractive layer may each independently include SiO₂ or SiCₓO_{y}N_{z}, and at least one among the low-refractive layers in the first to sixth stacked units may include SiCₓO_{y}N_{z}.

In an aspect, a refractive index of the high-refractive layer may be about 1.90 to about 2.30 at about 550 nm, and a refractive index of the low-refractive layer may be about 1.40 to about 1.60 at about 550 nm.

In an aspect, a hardness at an indentation depth of about 100 nm or less, as measured by a nano indenter, may be about 15 GPa or more.

In an aspect, a maximum hardness according to an indentation depth, as measured by the nano indenter, may be about 20 GPa or more.

In an aspect, an average SCI reflectance may be about 0.4% or less.

In an aspect of the present disclosure, an electronic apparatus includes a display module generating an image, and a cover window disposed on the display module. The cover window includes a base substrate, and an optical member disposed on the base substrate and including a plurality of stacked units, the stacked units each include a high-refractive layer, and a low-refractive layer disposed directly on the high-refractive layer and having a refractive index at least about 0.3 lower than that of the high-refractive layer, and the high-refractive layer includes a composite material including Ge, and a content of Ge in the composite material is about 10 at % to about 50 at %.

In an aspect, the high-refractive layer may include at least one among a Ge₃N₄, an Al—Ge—N composite material and an Al—Ge—O—N composite material, and the low-refractive layer may include at least one among SiO₂, SiON, and SiCₓO_{y}N_{z}.

In an aspect, the stacked units may include first to sixth stacked units, sequentially stacked in a thickness direction, the optical member may further include a base low-refractive layer directly disposed between the base substrate and the first stacked unit, the high-refractive layer included in each of the first to sixth stacked units may include an Al—Ge—N composite material, the low-refractive layers in the first to sixth stacked units and the base low-refractive layer may each independently include SiO₂ or SiCₓO_{y}N_{z}, and at least one among the low-refractive layers in the first to sixth stacked units may include SiCₓO_{y}N_{z}.

In an aspect, the cover window may have a hardness of about 15 GPa or greater at an indentation depth of about 100 nm or less, as measured by a nano indenter, and an average SCI reflectance of about 5% or less.

In an aspect, at least one among a power module, a processor, and a memory may further be included.

### BRIEF DESCRIPTION OF THE FIGURES

The accompanying drawings are included to provide a further understanding of the present disclosure, and are incorporated in and constitute a part of this specification. The drawings illustrate aspects of the present disclosure and, together with the description, serve to explain principles of the present disclosure. In the drawings:

FIG. 1 is a block diagram of an electronic apparatus according to an aspect;

FIG. 2 shows schematic views of electronic apparatuses according to aspects;

FIG. 3 is a perspective view of an electronic apparatus according to an aspect;

FIG. 4 is an exploded perspective view of an electronic apparatus according to an aspect;

FIG. 5 is a cross-sectional view of a cover window according to an aspect;

FIG. 6 is a cross-sectional view of an optical member according to an aspect;

FIG. 7 is a cross-sectional view of an optical member according to an aspect;

FIG. 8 is a graph showing a change in refractive index versus a content of materials for a high-refractive layer;

FIG. 9A is a graph showing a change in refractive index versus a flow rate of methane (CH₄) gas;

FIG. 9B is a graph showing a change in hardness versus a flow rate of methane (CH₄) gas; and

FIG. 10 is a graph showing a change in hardness versus an indentation depth.

### DETAILED DESCRIPTION

In this specification, it will be understood that when an element (or a region, a layer, a portion, or the like) is referred to as being “on”, “connected to” or “coupled to” another element, it may be directly disposed on, connected to, or coupled to the other element, or other elements may be disposed therebetween.

Like reference numerals or symbols refer to like elements throughout. In the drawings, the thickness, ratio, and size of the elements are exaggerated for effectively describing the technical contents. As used herein, the term “and/or” includes any and all combinations of one or more of the associated listed elements.

It will be understood that, although the terms “first”, “second”, etc. may be used herein to describe various elements, the elements are not to be limited by these terms. These terms are only used to distinguish one element, component, region, layer or section from another element, component, region, layer or section. For instance, a first element, component, region, layer or section discussed below could be termed a second element, component, region, layer or section without departing from the scope of the present disclosure. Similarly, a second element, component, region, layer or section could be termed a first element, component, region, layer or section. In this specification, the singular expressions “a”, “an” and “the” are intended to include the plural forms as well, unless the context clearly indicates otherwise.

In addition, the terms “below”, “under”, “on the lower side”, “above”, “over”, “on the upper side”, or the like may be used to describe the relationships between the elements illustrated in the drawings. These terms are relative concepts and are described on the basis of the directions indicated in the drawings.

It will be further understood that the terms “comprises, includes, has” and/or “comprising, including, having”, when used in this specification, specify the presence of stated features, numbers, steps, operations, elements, components or combinations thereof, but do not preclude the possibility of the presence or addition of one or more other features, numbers, steps, operations, elements, components, and/or combinations thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, an optical member according to an aspect, a cover window according to an aspect, and an electronic apparatus according to an aspect are described with reference to the drawings.

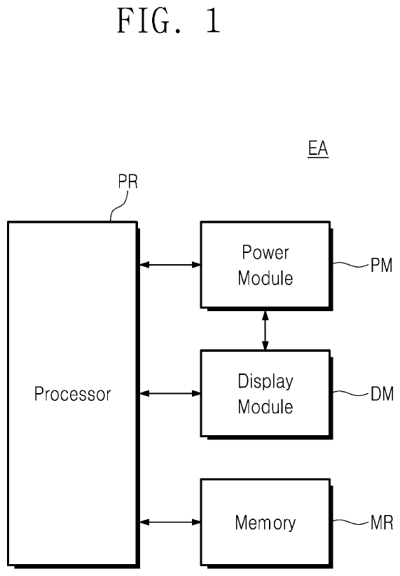

FIG. 1 is a block diagram according to an aspect. Referring to FIG. 1, an electronic apparatus EA according to an aspect may include a display module DM, a processor PR, a memory MR, and a power module PM.

The processor PR may include at least one among a central processing unit (CPU), an application processor (AP), a graphic processing unit (GPU), a communication processor (CP), an image signal processor (ISP), and a controller.

The memory MR may store data information needed for the operations of the processor PR or the display module DM. When the processor PR executes an application stored in the memory MR, an image data signal and/or an input control signal are transmitted to the display module DM, and the display module DM may process the received signal and output image information through a display screen. The display module DM may include a display panel displaying an image.

The power module PM may include a power supply module such as a power adaptor or a battery device, and a power conversion module that converts power supplied by the power supply module to generate power needed for operations of the electronic apparatus EA.

The electronic apparatus EA may include a display device that generates and displays an image. The display device may be a unit including a display module DM. In addition, some of components or individual modules of the above-described electronic apparatus EA may be included in the display device, and some others may be provided separately from the display device. For example, the display device may include the display module DM, and the processor PR, the memory MR, and the power module PM may be provided in the electronic apparatus EA, in the form of a device that is not the display device.

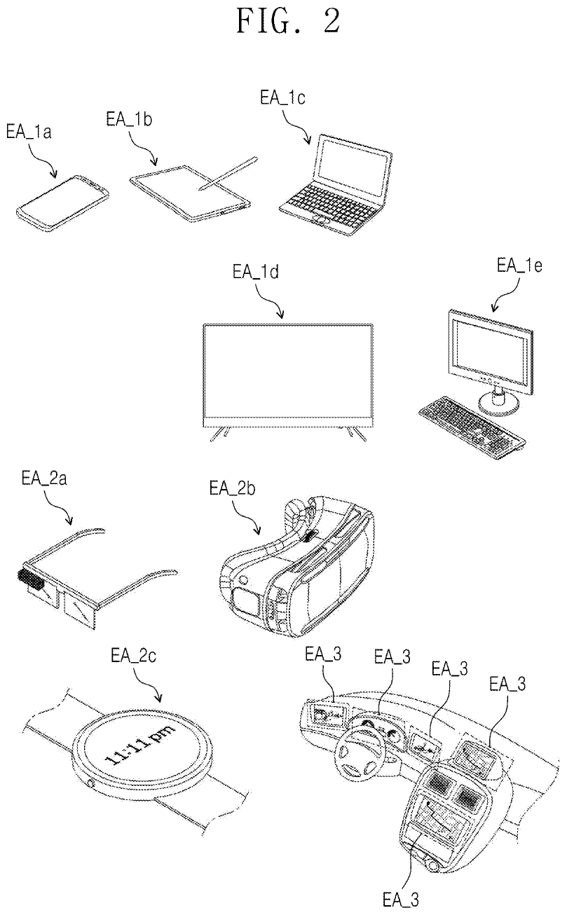

FIG. 2 shows schematic views of electronic apparatuses according to various aspects.

Referring to FIG. 2, various electronic apparatuses including the display device according to an aspect may not include only an image-displaying electronic apparatus such as a smart phone EA_1a, a tablet PC EA_1b, a laptop computer EA_1c, a TV EA_1d, and a desktop monitor EA_1e, but also include a wearable electronic apparatus such as smart glasses EA_2a, a head mounted display EA_2b, or a smart watch EA_2c, and a vehicular electronic apparatus EA_3 such as a center information display (CID) located on a vehicle's instrument cluster, center fascia, or dashboard, a room mirror display, etc.

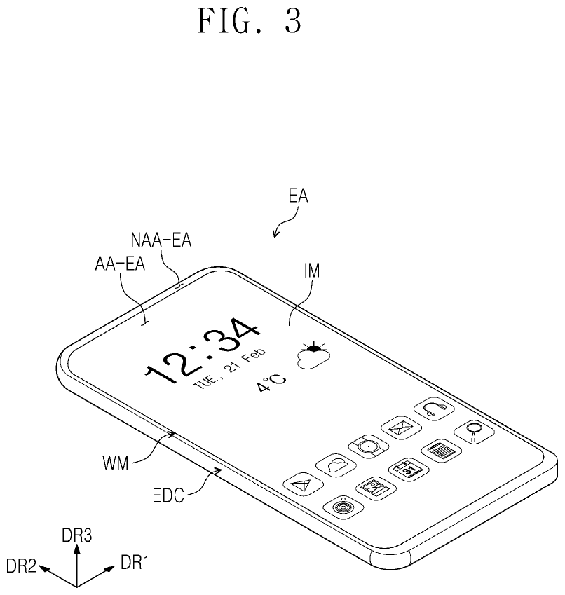

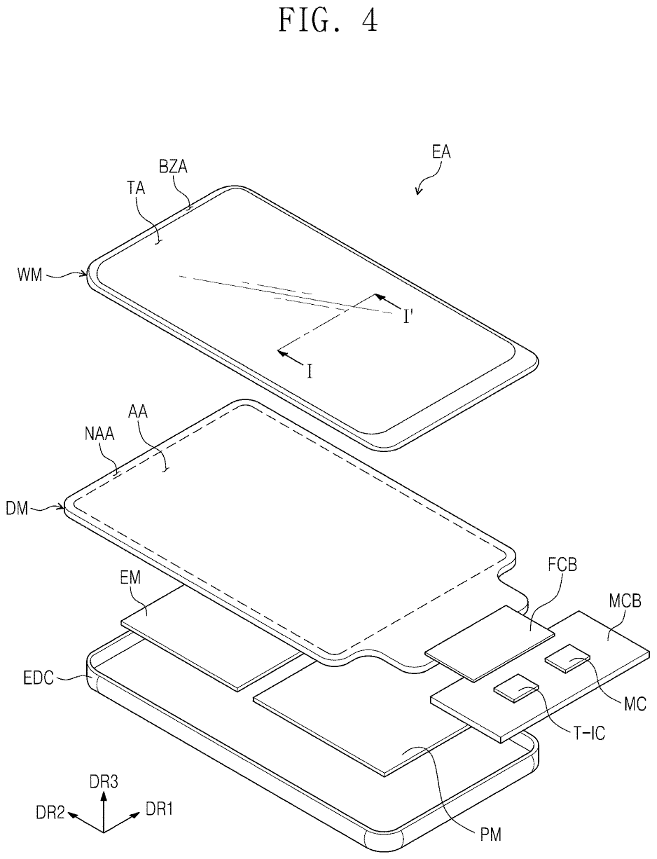

FIG. 3 is a perspective view illustrating an electronic apparatus according to an aspect. FIG. 4 is an exploded perspective view of an electronic apparatus according to an aspect.

FIG. 3 illustrates a smart phone as an example of the electronic apparatus EA. However, the details of the electronic apparatus EA described with reference to FIG. 3 and the like may be similarly applied to other electronic apparatuses.

The electronic apparatus EA may be rigid or flexible. The term “flexible” refers to bendable properties. For example, the flexible electronic apparatus EA may include a curved apparatus, a rollable apparatus, or a foldable apparatus.

FIG. 3 and the following drawings illustrate first direction axis DR1 to third direction axis DR3, and directions indicated by the first to third direction axes DR1, DR2, and DR3 which are described in this specification are relative concepts and may convert to other directions. In addition, the directions indicated by the first to third direction axes DR1, DR2, and DR3 may be described as first to third directions DR1, DR2, and DR3, and the same reference symbols or numerals may be used. In this specification, the first direction axis DR1 and the second direction axis DR2 may be perpendicular to each other, and the third direction axis DR3 may be a normal direction with respect to a plane defined by the first direction axis DR1 and the second direction axis DR2.

A thickness direction of the electronic apparatus EA may be parallel to the third direction axis DR3, which is a normal direction with respect to the plane defined by the first direction axis DR1 and the second direction axis DR2. In this specification, a front surface (or top surface) and a rear surface (or bottom surface) of each member constituting the electronic apparatus EA may be defined with respect to the third direction axis DR3. The front surface (or top surface) and the rear surface (or bottom surface) of each member constituting the electronic apparatus EA may be opposed to each other in the third direction DR3, and a normal direction of each of the front surface and the rear surface may be parallel to the third direction DR3, substantially. A separation distance between the front surface and the rear surface, which is defined along the third direction DR3, may correspond to a thickness of the member.

In this specification, the term “on the plane” may be defined as a state viewed from the third direction DR3. In this specification, the term “on a cross-section” may be defined as a state viewed from the first direction DR1 or the second direction DR2. The directions indicated by the first to third directions DR1, DR2 and DR3 are relative concepts and may be converted into other directions.

The electronic apparatus EA according to an aspect may display an image IM through an active region AA-EA. The active region AA-EA may include a flat surface defined by the first direction DR1 and the second direction DR2. The active region AA-EA may further include a curved surface which is bent from at least one side of the flat surface defined by the first direction DR1 and the second direction DR2. The surface on which an image IM is displayed may correspond to a front surface of the electronic apparatus EA. The image IM may include a still image as well as an active image.

A peripheral region NAA-EA is adjacent to the active region AA-EA. The peripheral region NAA-EA may surround the active region AA-EA. Therefore, a shape of the active region AA-EA may be defined substantially by the peripheral region NAA-EA. However, this is illustrated as an example, the peripheral region NAA-EA may be disposed adjacent to only one side of the active region AA-EA or may be omitted. The electronic apparatus EA according to an aspect of the present disclosure may include an active region in various shapes but is not limited to any one aspect.

The electronic apparatus EA may be a rectangular shape having short sides extending in the first direction DR1 and long sides extending in the second direction DR2 which crosses the first direction DR1. However, an aspect of the present disclosure is not limited thereto, and the electronic apparatus EA may have, on a plane, various shapes such as a circular shape, and a polygonal shape.

The electronic apparatus EA may detect an external input applied from the outside. The external input may include various types of inputs such as force, pressure, temperature, and light.

Referring to FIG. 3 and FIG. 4, the electronic apparatus EA according to an aspect may include a display module DM and a cover window WM according to an aspect disposed on the display module DM. The electronic apparatus EA according to an aspect may further include an electronic module EM, a power module PM, a housing EDC, etc. In addition, the electronic apparatus EA according to an aspect may further include at least one among a processor PR (FIG. 1) and a memory MR (FIG. 1) in addition to the display module DM and the power module PM supplying power to the display module DM.

The display module DM may be a component that generates an image, and detects an input applied from the outside. The display module DM according to an aspect may include a component such as a display panel generating an image and an input sensor detecting an input applied from the outside.

In the electronic apparatus EA according to an aspect, the display panel may be a light-emitting-type display panel and may be, for example, an organic light-emitting display panel, an inorganic light-emitting display panel, a quantum dot display panel, a micro-LED display panel, or a nano LED display panel. The display panel may be referred to as a display layer.

In the display module DM, an active region AA and a peripheral region NAA may be defined. The active region AA may be a region activated in response to an electrical signal. The peripheral region NAA may be a region located adjacent to at least one side of the active region AA.

The active region AA may correspond to the active region AA-EA of the electronic apparatus illustrated in FIG. 3. The peripheral region NAA may be positioned covering the active region AA. However, an aspect is not limited thereto, and unlike what is illustrated in FIG. 4 and the like, in an aspect, a portion of the peripheral region NAA may be omitted. The peripheral region NAA may correspond to the peripheral region NAA-EA of the electronic apparatus illustrated in FIG. 3.

The display module DM according to an aspect may include a peripheral region NAA disposed on at least one side of the active region AA, and an operating circuit, an operating wiring, or the like may be disposed in a portion of the peripheral region NAA.

The display module DM may include a main circuit board MCB and a flexible circuit film FCB that electrically connects the main circuit board MCB and the display module DM. In addition, the main circuit board MCB may be electrically connected to the electronic module EM via a connector.

In the main circuit board MCB, a sensor control circuit T-IC, a main controller MC, and the like may be disposed. The main controller MC may control an overall operation of the electronic apparatus EA. For example, the main controller may control an operation of the display panel, the input sensor, and the like. In addition, the main controller MC may control an operation of the electronic module EM. The main controller MC may include at least one microprocessor.

The flexible circuit film FCB may be connected to the display panel, the input sensor, and the like, and thus the display panel, and the input sensor may be electrically connected to the main circuit board MCB. The input sensor may be electrically connected to the display panel and thus may also be electrically connected to the main circuit board MCB through the flexible circuit film FCB. However, an aspect is not limited thereto, and the input sensor may be electrically connected to the main circuit board MCB through an additional flexible circuit film. Alternatively, the flexible circuit film FCB may be omitted and the main circuit board MCB may also be directly connected on the display panel.

The electronic module EM may include various functional modules needed for the operation of the electronic apparatus EA. For example, the electronic module EM may include a wireless communication module, an image input module, a sound input module, a sound output module, a memory, an external interface module, etc. The modules of the electronic module EM may be mounted on the main circuit board MCB or may be electrically connected to the main circuit board MCB through an additional flexible circuit board.

The power module PM may be electrically connected to the electronic module EM. The power module PM may supply power needed for an overall operation of the electronic apparatus EA. For example, the power module PM may include a commercial battery device.

The cover window WM and the housing EDC may combine with each other and form an exterior of the electronic apparatus EA. The cover window WM and the housing EDC may combine with each other and form an interior space accommodating components of the electronic apparatus EA. The interior space may accommodate the display module DM, the flexible circuit film FCB, the main circuit board MCB, the electronic module EM, the power module PM, etc. A portion of the display module DM may be bent such that the flexible circuit film FCB and the main circuit board MCB face a rear surface of the display module DM and may be accommodated in the housing EDC.

The housing EDC may include a material having relatively high rigidity. For example, the housing EDC may include a frame and/or a plate, including glass, plastic, or metal, or formed of a combination thereof. The housing EDC may absorb an impact applied from the outside or prevent foreign materials/moisture from penetrating from the outside and thus the display module accommodated in the housing EDC may be protected.

The cover window WM according to an aspect may be disposed on the display module DM and thus protect the display module DM from external impact or scratch. The cover window WM may cover the entire exterior of the display module DM. A front surface of the cover window WM may correspond to a top surface of the above-described electronic apparatus EA.

The cover window WM according to an aspect may be divided into a transmissive region TA and a bezel region BZA. The transmissive region TA may be a region corresponding to the active region AA of the display module DM, and the bezel region BZA may be a region corresponding to the peripheral region NAA of the display module DM. The bezel region BZA may define a shape of the transmissive region TA. The bezel region BZA may be adjacent to the transmissive region TA and may surround the transmissive region TA. However, an aspect is not limited to what is illustrated, and the bezel region BZA may be disposed adjacent to only one side of the transmissive region TA, or a portion thereof may also be omitted. The bezel region BZA of the cover window WM according to an aspect may have a lower light transmittance than the transmissive region TA.

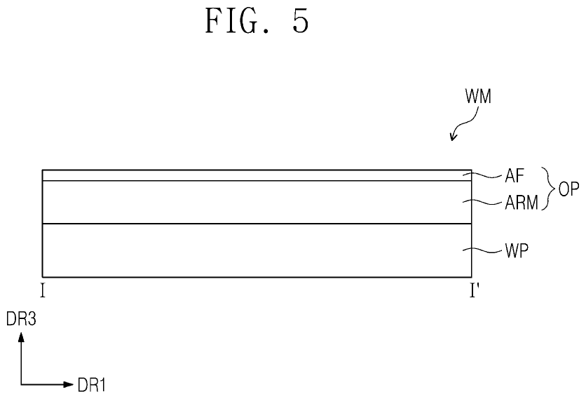

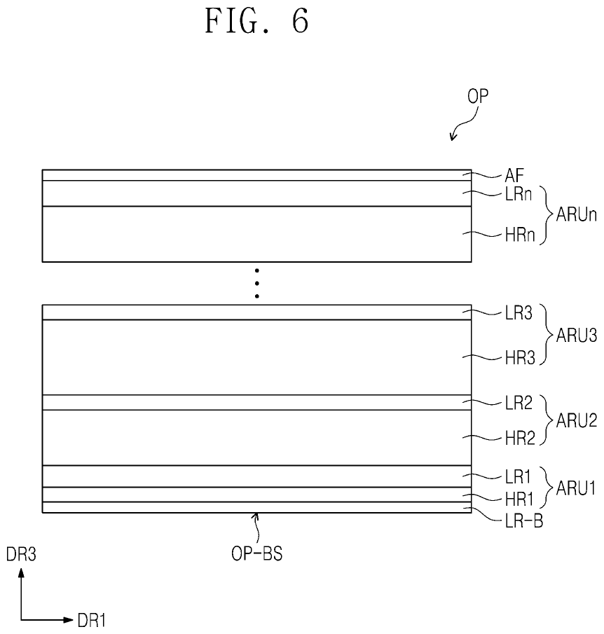

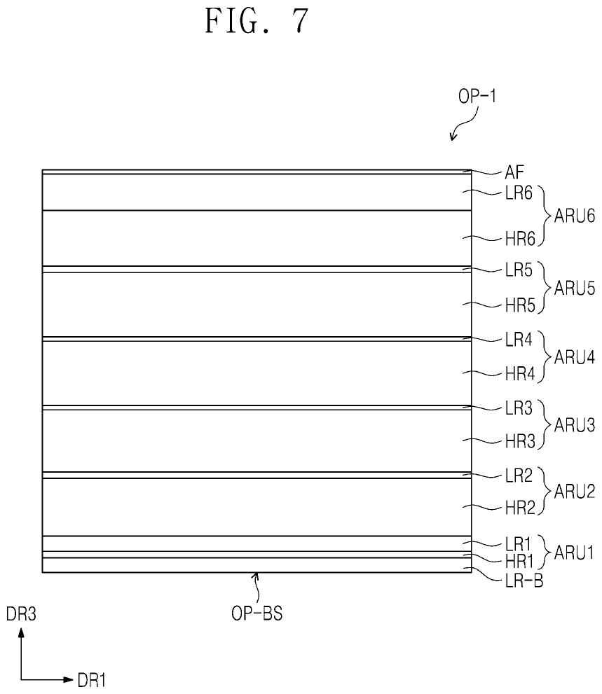

FIG. 5 is a cross-sectional view of a cover window according to an aspect, and FIG. 6 and FIG. 7 are each a cross-sectional view of an optical member according to an aspect. FIG. 5 may be a cross-sectional view of a portion taken along line I-I′ in FIG. 4.

The cover window WM according to an aspect may include a base substrate WP which is an optically transparent insulating material. The base substrate WP may include an optically transparent insulating material. The base substrate WP may include at least one among a glass substrate and a synthetic resin film. The base substrate WP may have a single layer structure or a multilayer structure in which a plurality of films combines. The base substrate WP may be a glass substrate or a polymer substrate. For example, the base substrate WP may be an enhanced glass substrate. In an aspect, an ultra-thin film-type enhanced glass substrate may be used as a base substrate WP of the cover window WM.

The cover window WM according to an aspect may include an optical member OP according to an aspect disposed on the base substrate WP. The optical member OP according to an aspect may function as a reflection reduction member, which reduces reflection of external light.

The optical member OP according to an aspect may include a reflection reduction layer ARM. The optical member OP according to an aspect may further include an anti-fingerprint layer AF disposed on the reflection reduction layer ARM. In addition, the optical member OP according to an aspect may further include a functional layer such as a hard coating layer and an anti-fouling layer.

The cover window WM may further include an adhesive layer (not illustrated). The base substrate WP and the display module DM (FIG. 4) may combine through the adhesive layer (not illustrated). However, an aspect of the present disclosure is not limited thereto, the adhesive layer may be omitted, and the base substrate WP of the cover window WM may be directly disposed on the display module DM (FIG. 4).

In this specification, when an element is referred to as being “directly disposed on,” other layers, membranes, regions, or plates, there are no intervening layers, membranes, regions, or plates present. For example, “directly disposed on” may mean that two layers or two members are directly disposed without using an additional intervening member, such as an adhesive member.

The reflection reduction layer ARM may be named as an anti-reflection layer. The reflection reduction layer ARM may function to reduce reflected light when light incident from the outside is reflected at the display module and the like. In an aspect, the reflection reduction layer ARM may effectively absorb or refract broadband light, and thus an amount of reflected light may be reduced.

The optical member OP including the reflection reduction layer ARM reduces reflected light by being disposed on the display module that generates an image, and the like, and thus the image provided by the display module DM may have improved clarity. The optical member OP according to an aspect may reduce distortion of color due to reflection and thus may improve color sensitivity that the provided image expresses.

In addition, since the optical member OP according to an aspect has high-hardness properties, the optical member OP may be disposed on the display module and effectively protect the display module. In addition, the cover window WM according to an aspect including the optical member OP according to an aspect has an improved surface hardness and thus may have strong scratch resistance properties against external stimuli, or external force.

Referring to FIG. 6, the optical member OP according to an aspect may include a plurality of stacked units ARU1, ARU2, ARU3, . . . , and ARUn, which include high-refractive layers HR1, HR2, HR3, . . . , and HRn and low-refractive layers LR1, LR2, LR3, . . . , and LRn, respectively. The plurality of stacked units ARU1, ARU2, ARU3, . . . , and ARUn may form the reflection reduction layer ARM.

The optical member OP according to an aspect may include n stacked units ARU1, ARU2, ARU3, . . . , and ARUn, which are sequentially stacked and disposed in a thickness direction. In FIG. 6, the “n” may be an integer of 1 or greater. For example, the optical member OP according to an aspect may include three or more stacked units.

In the optical member OP according to an aspect, the low-refractive layers LR1, LR2, LR3, . . . , and LRn of stacked units may be directly disposed on the high-refractive layers HR1, HR2, HR3, . . . , and HRn, respectively. In addition, the optical member OP according to an aspect may further include a base low-refractive layer LR-B disposed below a lowest stacked unit ARU1. The base low-refractive layer LR-B may be adjacent to the base substrate WP of the cover window WM. In an aspect, a bottom surface of the base low-refractive layer LR-B may be a bottom surface OP-BS of the optical member OP and may be a surface in contact with the base substrate WP.

In the optical member OP according to an aspect, the reflection reduction layer ARM may include a structure in which high-refractive layers HR1, HR2, HR3, . . . , and HRn and the low-refractive layers LR1, LR2, LR3, . . . , and LRn are stacked in turn. In an aspect, the stacked units ARU1, ARU2, ARU3, . . . , and ARUn may respectively include the high-refractive layers HR1, HR2, HR3, . . . , and HRn, and the low-refractive layers LR1, LR2, LR3, . . . , and LRn, which are directly disposed on the high-refractive layers. In addition, a high-refractive layer in an upper stacked unit may be directly disposed on a low-refractive layer in a lower stacked unit thereof.

For example, a first stacked unit ARU1 may include a first high-refractive layer HR1 and a first low-refractive layer LR1 directly disposed on the first high-refractive layer HR1, a second stacked unit ARU2 may include a second high-refractive layer HR2 and a second low-refractive layer LR2 directly disposed on the second high-refractive layer HR2, and a third stacked unit ARU3 may include a third high-refractive layer HR3 and a third low-refractive layer LR3 directly disposed on the third high-refractive layer HR3.

In the optical member OP according to an aspect, the high-refractive layers HR1, HR2, HR3, . . . , and HRn, and the low-refractive layers LR1, LR2, LR3, . . . , and LRn may each be formed through deposition by sputtering or E-beam deposition.

In an aspect, the high-refractive layers HR1, HR2, HR3, . . . , and HRn may each be a composite material layer including germanium (Ge). For example, in an aspect, the high-refractive layers HR1, HR2, HR3, . . . , and HRn may include at least one among Ge₃N₄, Al—Ge—N composite materials, and Al—Ge—O—N composite materials. The Al—Ge—O—N composite materials may be formed by reaction of Al—Ge—N composite materials with oxygen (O₂) introduced during formation of the high-refractive layers HR1, HR2, HR3, . . . , and HRn.

A content of Ge in the high-refractive layers HR1, HR2, HR3, . . . , and HRn may be about 10 at % to about 50 at %. As herein used, “at %” means atomic percentage. For example, the amount of Ge in the high-refractive layers HR1, HR2, HR3, . . . , and HRn may be about 30 at % to about 40 at %. When the high-refractive layers HR1, HR2, HR3, . . . , and HRn each include Al—Ge—N composite materials, the content of Ge therein may be about 10 at % to about 50 at %. When the content of Ge in each of the high-refractive layers HR1, HR2, HR3, . . . , and HRn falls within about 10 at % to about 50 at %, the high-refractive layers HR1, HR2, HR3, . . . , and HRn may exhibit a high refractive index and strong hardness properties at the same time.

In addition, the high-refractive layers HR1, HR2, HR3, . . . , and HRn may include O due to oxygen (O₂) introduced during a process. A content of O in the high-refractive layers HR1, HR2, HR3, . . . , and HRn may be less than about 20 at %. For example, when the high-refractive layers HR1, HR2, HR3, . . . , and HRn each include Al—Ge—O—N composite materials, the content of O therein may be about 20 at % or less.

In an aspect, all the high-refractive layers HR1, HR2, HR3, . . . , and HRn in a plurality of stacked units ARU1, ARU2, ARU3, . . . , and ARUn included in the optical member OP include Al—Ge—N composite materials, and in this case, a content of Ge may be about 10 at % to about 50 at %. In addition, in an aspect, all the high-refractive layers HR1, HR2, HR3, . . . , and HRn in the plurality of stacked units ARU1, ARU2, ARU3, . . . , and ARUn include Al—Ge—N composite materials, and in this case the content of Ge may be about 30 at % to about 40 at %.

In the optical member OP according to an aspect, the low-refractive layers LR1, LR2, LR3, . . . , and LRn may include at least one among SiO₂, SiON, and SiCₓO_{y}N_{z}. In an aspect, in the plurality of stacked units ARU1, ARU2, ARU3, . . . , and ARUn, the low-refractive layers LR1, LR2, LR3, . . . , and LRn may each independently include SiO₂, SiON, or SiCₓO_{y}N_{z} as low-refractive materials. For example, in an aspect, at least one among the low-refractive layers LR1, LR2, LR3, . . . , and LRn may include SiCₓO_{y}N_{z} and the other low-refractive layers may include SiO₂. In SiCₓO_{y}N_{z}, x, y, and z may each be 0 or greater.

When SiCₓO_{y}N_{z} is included as materials for the low-refractive layers LR1, LR2, LR3, . . . , and LRn, SiCₓO_{y}N_{z} may include a bonding structure of Si—Si, Si—C, Si—N, Si—O, and Si—(O)₄. The bonding structures of Si—Si, Si—C, Si—N, Si—O, and Si—(O)₄ may be mixed and included in the low-refractive layers LR1, LR2, LR3, . . . , and LRn.

In the optical member OP according to an aspect, at least one among the plurality of stacked units ARU1, ARU2, ARU3, . . . , and ARUn may include SiCₓO_{y}N_{z} in the low-refractive layer. In addition, in the optical member OP according to an aspect, all the low-refractive layers LR1, LR2, LR3, . . . , and LRn of the plurality of stacked units ARU1, ARU2, ARU3, . . . , and ARUn may include SiCₓO_{y}N_{z}. In the optical member OP according to an aspect, at least one among the plurality of stacked units ARU1, ARU2, ARU3, . . . , and ARUn includes SiCₓO_{y}N_{z} in the low-refractive layer, and thus high-hardness properties may be exhibited.

In an aspect, differences respectively between the high-refractive layers HR1, HR2, HR3, . . . , and HRn and the low-refractive layers LR1, LR2, LR3, . . . , and LRn may be about 0.3 or greater. The low-refractive layers LR1, LR2, LR3, . . . , and LRn may have at least about 0.3 smaller refractive index than a refractive index of the high-refractive layers HR1, HR2, HR3, . . . , and HRn, respectively.

In an aspect, the high-refractive layers HR1, HR2, HR3, . . . , and HRn may each have a refractive index of about 1.90 to about 2.30. For example, the refractive index of each of the high-refractive layers HR1, HR2, HR3, . . . , and HRn may be about 2.10 to about 2.20. The high-refractive layers HR1, HR2, HR3, . . . , and HRn may each necessarily include Ge. Ge is included in an amount of about 10 at % or more, and thus high-hardness and high-refractive index properties may be exhibited at the same time.

In an aspect, the low-refractive layers LR1, LR2, LR3, . . . , and LRn may have a refractive index of about 1.40 to about 1.60. For example, the refractive index of each of the low-refractive layers LR1, LR2, LR3, . . . , and LRn may be about 1.46 to about 1.60. Specifically, the refractive index of each of the low-refractive layers LR1, LR2, LR3, . . . , and LRn may be about 1.46 to about 1.48. Since the low-refractive layers LR1, LR2, LR3, . . . , and LRn each have the refractive index of about 1.46 to about 1.60, optical properties which induce destructive interference of light reflected from each layer or reverse a phase of reflected light due to a difference in refractive index with the high-refractive layer, may be improved, and thus reflected light may be effectively reduced through the optical member OP.

The optical member OP according to an aspect includes, in plurality, the stacked units respectively including the high-refractive layers HR1, HR2, HR3, . . . , and HRn each having a refractive index of about 1.90 to about 2.30 and the low-refractive layers LR1, LR2, LR3, . . . , and LRn each having a refractive index of about 1.40 to about 1.60, and thus high-hardness and properties of low-refractive index may be exhibited at the same time. In this specification, the refractive index is measured at a wavelength of about 550 nm.

In an aspect, an average thickness of the high-refractive layers HR1, HR2, HR3, . . . , and HRn may be larger than an average thickness of the low-refractive layers LR1, LR2, LR3, . . . , and LRn. In the optical member OP according to an aspect, thicknesses of the high-refractive layers HR2, HR3, . . . , and HRn may be respectively larger than those of the low-refractive layers LR2, LR3, . . . , and LRn in the stacked units except for the lowest stacked unit ARU1.

In the optical member OP according to an aspect, the reflection reduction layer ARM may further include the base low-refractive layer LR-B, and in an aspect, the base low-refractive layer LR-B may be disposed below the lowest stacked unit ARU1 among the plurality of stacked units ARU1, ARU2, ARU3, . . . , and ARUn. The base low-refractive layer LR-B may be disposed directly under a high-refractive layer HR1 in the first stacked unit ARU1. The base low-refractive layer LR-B may be included in the reflection reduction layer ARM.

The base low-refractive layer LR-B may include at least one among SiO₂, SiON, and SiCₓO_{y}N_{z}. The base low-refractive layer LR-B may have a refractive index of about 1.40 to about 1.60. For example, the base low-refractive layer LR-B may include SiO₂, or SiCₓO_{y}N_{z}.

The base low-refractive layer LR-B may increase adhesion between the stacked units ARU1, ARU2, ARU3, . . . , and ARUn and the base substrate WP. The base low-refractive layer LR-B includes at least one among SiO₂, SiON, and SiCₓO_{y}N_{z}, and thus may increase adhesion between the base substrate WP, which is a glass substrate, and the high-refractive layer HR1.

The optical member OP according to an aspect may further include an anti-fingerprint layer AF. The anti-fingerprint layer AF may include a fluorine-based polymer.

The anti-fingerprint layer AF may be disposed on an uppermost stacked unit among the stacked units ARU1, ARU2, ARU3, . . . , and ARUn. The anti-fingerprint layer AF may be disposed on an n-th stacked unit ARUn. In an aspect, the anti-fingerprint layer AF may be disposed on a n-th low-refractive layer LRn in the n-th stacked unit ARUn. For example, in an aspect, the anti-fingerprint layer AF may be disposed directly on the n-th low-refractive layer LRn in the n-th stacked unit ARUn.

In an aspect, the anti-fingerprint layer AF may have a thickness of about 10 nm to about 30 nm. For example, the anti-fingerprint layer AF may have a thickness of about 20 nm.

FIG. 7 is a cross-sectional view of an optical member according to an aspect. The optical member OP-1 according to an aspect, illustrated in FIG. 7, differs only in that it is illustrated to include six stacked units from the optical member OP according to an aspect, illustrated in FIG. 6. The details described with reference to FIG. 6 may be similarly applied to details for the optical member OP-1 according to an aspect illustrated in FIG. 7.

The optical member OP-1 according to an aspect may include a first stacked unit ARU1, a second stacked unit ARU2, a third stacked unit ARU3, a fourth stacked unit ARU4, a fifth stacked unit ARU5, and a sixth stacked unit ARU6, which are sequentially stacked in a thickness direction. The stacked units may include high-refractive layers HR1, HR2, . . . , and HR6 and low-refractive layers LR1, LR2, . . . , and LR6 disposed directly on the high-refractive layer, respectively.

The optical member OP-1 according to an aspect may further include a base low-refractive layer LR-B disposed directly under the first high-refractive layer HR1 of the first stacked unit. In addition, the optical member OP-1, according to an aspect, may further include an anti-fingerprint layer AF disposed on the sixth stacked unit ARU6.

A bottom surface of the base low-refractive layer LR-B is a bottom surface OP-BS of the optical member OP-1 and may be a surface in contact with the base substrate WP (FIG. 5).

The optical member OP-1 according to an aspect may include the first stacked unit ARU1, the second stacked unit ARU2, the third stacked unit ARU3, the fourth stacked unit ARU4, the fifth stacked unit ARU5, and the sixth stacked unit ARU6, which are sequentially stacked, and the base low-refraction layer LR-B disposed under the first stacked unit ARU1. In the optical member OP-1 according to an aspect, the first to sixth high-refractive layers HR1, HR2, . . . , and HR6 respectively included in the first to sixth stacked units ARU1, ARU2, . . . , and ARU6 may each include Al—Ge—N composite materials, the first to sixth low-refractive layers LR1 LR2, . . . , and LR6, and the base low-refractive layer LR-B may each independently include SiO₂, or SiCₓO_{y}N_{z}, and at least one low-refractive layer in the first to sixth stacked units ARU1, ARU2, . . . , and ARU6 may include SiCₓO_{y}N_{z}.

The optical member OP-1, according to an aspect, described with reference to FIG. 6 and FIG. 7, includes a plurality of stacked units each including a high-refractive layer and a low-refractive layer, Ge composite materials including Ge of about 10 at % to about 50 at % is included in each of the high-refractive layer, and thus properties of high-hardness and low-reflectance may be exhibited. The optical members OP and OP-1 according to an aspect include Ge composite materials including Ge of about 10 at % to about 50 at % in each of high-refractive layers, and thus properties of a high-surface hardness value and excellent reflection reduction may be exhibited. The optical members OP and OP-1 according to an aspect include a high-refractive layer including Ge composite materials that includes Ge in an amount of about 10 at % to about 50 at %, and thus may function as a reflection reduction member having high-hardness properties and excellent optical properties of low reflectance at the same time.

The optical members OP and OP-1 according to an aspect, described with reference to FIG. 6 and FIG. 7 may be included in the cover window WM in FIG. 5, and the cover window WM according to an aspect may exhibit high-hardness and excellent reflection reduction properties.

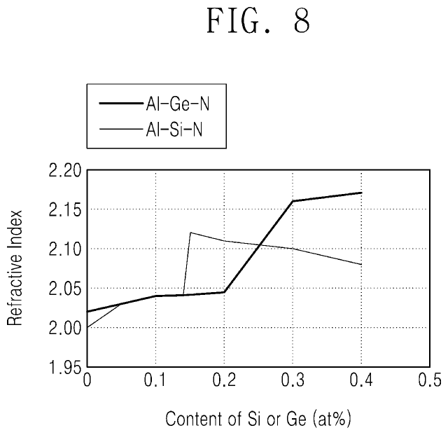

FIG. 8 is a graph comparing a change in a refractive index when materials for the high-refractive layer include “Si” or “Ge”. In FIG. 8, Al—Si—N is a Comparative Example and corresponds to a high-refractive layer material without Ge. AL-Ge—N is an Example according to an aspect of the present disclosure and corresponds to a high-refractive layer material containing Ge. In FIG. 8, a value on the X axis indicates a content of Si (Comparative Example) or Ge (Example). In the graph, 0.1 on the X-axis corresponds to 10 at %, and 0.2 on the X-axis corresponds to 20 at %, etc.

Referring to FIG. 8, the line labeled Al—Ge—N corresponds to a layer formed of Al—Ge—N composite materials containing varying atomic percentages of Ge. When Ge is included in an amount of about 0.1 (10 at %) or more in Al—Ge—N, a refractive index of 2 or greater may be achieved. In addition, when Ge is included in an amount of about 0.3 (30 at %) or more in Al—Ge—N, the refractive index thereof significantly increases, compared to Al—Si—N, the Comparative Example. For instance, using Al—Ge—N one may obtain a refractive index about 0.05 or greater than that of Al—Si—N, the Comparative Example.

Al—Si—N, the Comparative Example, exhibits a maximum value of refractive index when a content of Si in the Al—Si—N composite materials is about 0.15 (15 at %), where the maximum value of refractive index is observed to be about 2.13 or less. In comparison, when the Ge content of Al—Ge—Nis varied from 0 at % to 40 at %, the maximum value of refractive index achieved is about 2.18, although potentially a higher refractive index may be obtained with greater Ge content.

Therefore, when the composite materials including Ge are used as the materials for high-refractive layer, the high-refractive layer may have a high refractive index. In addition, considering that a hardness of a layer generally increases as a refractive index of the layer increases, an optical member according to Example including Ge as a material for the high-refractive layer in an amount of about 10 at % or more may exhibit high-hardness and excellent optical properties.

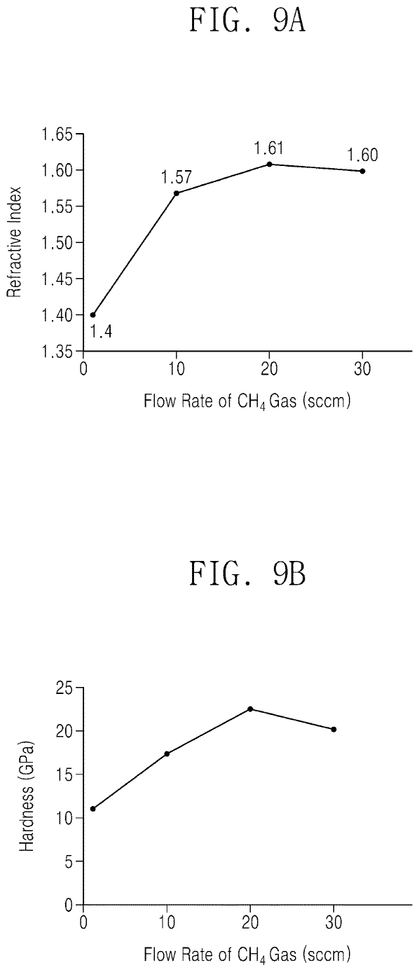

FIG. 9A and FIG. 9B each show a change in properties versus a flow rate of methane (CH₄) gas during formation of SiCₓO_{y}N_{z}, when SiCₓO_{y}N_{z} is used as materials for low-refractive layer. The flow rate of methane during formation of SiCₓO_{y}N_{z} affects the carbon (C) content of the SiCₓO_{y}N_{z} material. FIG. 9A shows a change in refractive index versus the flow rate of methane (CH₄) gas, and FIG. 9B shows a change in hardness versus the flow rate of methane (CH₄) gas.

Referring to FIG. 9A, it can be seen that as the flow rate of methane (CH₄) gas increases during formation, the refractive index of a layer increases. As the flow rate of methane (CH₄) gas increases up to about 20 sccm (standard cubic centimeters per minute), the refractive index may gradually increase. When the flow rate of methane (CH₄) gas exceeds about 20 sccm, the refractive index value converges to about 1.60. Referring to FIG. 9A, when the flow rate of methane (CH₄) gas is about 5 to about 10 sccm, the refractive index of the manufactured SiCₓO_{y}N_{z} layer may be about 1.46 to about 1.57.

Referring to FIG. 9B, it can be seen that as the flow rate of methane (CH₄) gas increases, a hardness of the SiCₓO_{y}N_{z} layer may increase. As the flow rate of methane (CH₄) gas increase up to about 20 sccm, the hardness may gradually increase. When the flow rate of methane (CH₄) gas exceeds about 20 sccm, the hardness slightly decreases. Referring to FIG. 9B, it can be confirmed that when the flow rate of methane (CH₄) gas is about 5 to about 10 sccm, the hardness of the manufactured SiCₓO_{y}N_{z} layer may be about 12 GPa to about 17 GPa. Such a hardness value corresponds to an about 10% or greater increase in hardness, compared to the SiO₂ layer having the same thickness, of which the hardness is about 8 GPa to about 9 GPa.

An optical member that meets conditions of refractive index and hardness, required in the low-refractive layer of the optical member, may be provided by controlling the flow rate of methane (CH₄) gas with reference to FIG. 9A and FIG. 9B. That is, in an aspect, the optical member including the low-refractive index, in which refractive index and hardness are optimized, may be provided by controlling a C content in SiCₓO_{y}N_{z}.

The cover window WM (FIG. 5) according to an aspect may have a hardness of about 15 GPa or greater at an indentation depth of about 100 nm or less.

The indentation hardness may be measured by a nano indenter. The cover window WM (FIG. 5) according to an aspect may have a maximum hardness of about 20 GPa or more according to the indentation depth, as measured by a nano indenter. The cover window WM (FIG. 5) according to an aspect including the above-described optical member according to an aspect, has a hardness of about 15 GPa or greater at a surface having the indentation depth of about 100 nm or less, and thus may have excellent surface hardness, impact resistance, and scratch resistance.

The cover window WM (FIG. 5) according to an aspect, including the optical member according to an aspect, may have an average specular component included (SCI) reflectance of about 4% or less. The cover window WM according to an aspect may have significantly improved reflectance by including an optical member according to an aspect, and thus excellent optical properties may be exhibited.

Such a cover window WM (FIG. 5) according to an aspect may be included in an electronic apparatus EA (FIG. 3). The cover window WM (FIG. 5) may define a top surface of the electronic apparatus EA (FIG. 3), may protect a display module and the like, which constitute the electronic apparatus EA (FIG. 3), may reduce reflected light which is reflected and emitted at the display module or the like, and may minimize distortion of coloration or the like of an image, provided from the display module. In addition, the cover window WM (FIG. 5) according to an aspect may reduce reflected light that is reflected from the display module DM (FIG. 4) and the like. Therefore, the electronic apparatus EA (FIG. 3) according to an aspect may have excellent reliability due to top surface having high-hardness properties and may exhibit excellent display quality properties at the same time.

Compositions of layers of the optical member according to Comparative Example and the optical members according to Examples are listed in Table 1 below. The cover windows respectively including the optical member according to Comparative Example and the optical members according to Examples in Table 1 were evaluated and the results are listed in Table 2.

Materials and thicknesses for each layer of the optical member according to Comparative Example, the optical member according to Example 1, and the optical member according to Example 2 are listed in Table 1. In the optical member according to Comparative Example, SiO₂ was used as the material for a low-refractive layer, and Si₃N₄ was used as the material for high-refractive layer. The refractive index of SiO₂, which was used as the low-refractive layer material, is about 1.47 at a wavelength of about 550 nm, and the refractive index of Si₃N₄, which was used as the high-refractive layer material is about 2.04 at a wavelength of about 550 nm. The optical member according to Example 1 and the optical member according to Example 2 each used SiCₓO_{y}N_{z} as the material for the low-refractive layer, and each used Al—Ge—N as the material for the high-refractive layer. In SiCₓO_{y}N_{z}, x, y, z are each 0 or greater. In Al—Ge—N, a content ratio of Ge/(Ge+Al+N) is about 0.33 to about 0.4.

The high-refractive layers used in the optical member according to Example 1 and the optical member according to Example 2 have a refractive index of about 2.15, the low-refractive layer in the optical member according to Example 1 has a refractive index of about 1.47, and the low-refractive layer of the optical member according to Example 2 has a refractive index of about 1.48.

The optical member according to Comparative Example, the optical member according to Example 1, and the optical member according to Example 2 in Table 1 each have a stacked structure as illustrated in FIG. 7. Table 1 shows each layer separately using the reference symbols and the numerals in FIG. 7.

TABLE 1

| | Optical member | | | | | |
|---|---|---|---|---|---|---|
| | according to | | Optical member | | Optical member | |
| | Comparative Example | | according to Example 1 | | according to Example 2 | |
| Stacked | | Thickness | | Thickness | | Thickness |
| component | Materials | (nm) | Materials | (nm) | Materials | (nm) |
| AF | | 10 | | 10 | | 10 |
| LR6 | SiO₂ | 84.8 | SiCₓO_{y}N_{z} | 85.1 | SiCₓO_{y}N_{z} | 72.7 |
| HR6 | Si₃N₄ | 152.2 | Al—Ge—N | 144.9 | Al—Ge—N | 120.9 |
| LR5 | SiO₂ | 12.3 | SiCₓO_{y}N_{z} | 13.2 | SiCₓO_{y}N_{z} | 14.1 |
| HR5 | Si₃N₄ | 185.6 | Al—Ge—N | 174.4 | Al—Ge—N | 147.0 |
| LR4 | SiO₂ | 10.0 | SiCₓO_{y}N_{z} | 10.0 | SiCₓO_{y}N_{z} | 21.4 |
| HR4 | Si₃N₄ | 182.6 | Al—Ge—N | 173.6 | Al—Ge—N | 157.9 |
| LR3 | SiO₂ | 10.0 | SiCₓO_{y}N_{z} | 10.0 | SiCₓO_{y}N_{z} | 20.2 |
| HR3 | Si₃N₄ | 174.6 | Al—Ge—N | 168.4 | Al—Ge—N | 157.0 |
| LR2 | SiO₂ | 13.9 | SiCₓO_{y}N_{z} | 13.2 | SiCₓO_{y}N_{z} | 20.8 |
| HR2 | Si₃N₄ | 156.9 | Al—Ge—N | 151.6 | Al—Ge—N | 145.2 |
| LR1 | SiO₂ | 34.8 | SiCₓO_{y}N_{z} | 35.0 | SiCₓO_{y}N_{z} | 37.8 |
| HR1 | Si₃N₄ | 16.6 | Al—Ge—N | 16.2 | Al—Ge—N | 12.8 |
| LR-B | SiO₂ | 35.6 | SiCₓO_{y}N_{z} | 35.8 | SiCₓO_{y}N_{z} | 10 |

The cover windows according to Comparative Example and Examples in which the optical members according to Comparative Example and Examples having the compositions in Table 1 were respectively disposed on a glass substrate which is a base substrate, were evaluated and the evaluated results are listed in Table 2.

TABLE 2

| | Comparative | | |
|---|---|---|---|
| Evaluation item | Example | Example 1 | Example 2 |
| Color coordinate (a*, b*) | −0.0, −1.9 | −0.0, −1.9 | −0.0, −2.0 |
| SCI reflectance (%) @ 550 | 0.49 | 0.34 | 0.38 |
| nm | | | |

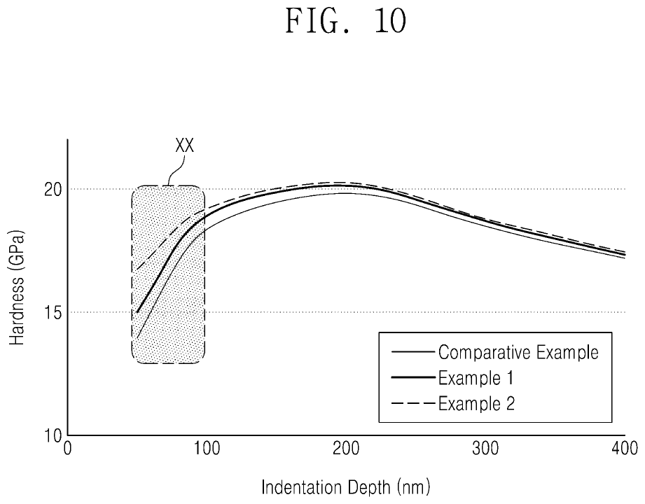

Referring to the results in Table 2, in the cases of Example 1 and Example 2, color coordinates similar to that of Comparative Example are exhibited. In addition, the cases of Example 1 and Example 2, reduced reflectance properties are exhibited compared to Comparative Example. Therefore, it can be said that cases of Examples where Al—Ge—N is included as the materials for high-refractive layer and SiCₓO_{y}N_{z} is used as the materials for the low-refractive layer and the base low-refractive layer, exhibit more improved reflection reduction properties while exhibiting similar coloration, compared to Comparative Example. FIG. 10 is a graph showing a change in hardness, according to an indentation depth. In FIG. 10, Comparative Example, Example 1, and Example 2 correspond to the cover windows according to Comparative Example, Example 1, and Example 2, evaluated in Table 2 above.

Referring to FIG. 10, in cases of Example 1 and Example 2, compared to Comparative Example, improved hardness properties are exhibited throughout an entire indentation depth range. Particularly, Example 1 and Example 2, compared to Comparative Example exhibit significantly improved properties in hardness at the indentation depth of about 50 nm to about 100 nm, where is a portion marked as a XX region. The portion marked as an XX region corresponds to a portion having a small indentation depth, that is, corresponds to a portion adjacent to a surface of the optical member, therefore, it can be confirmed that the cases of Examples exhibit improved properties in surface hardness, compared to Comparative Example.

The optical member according to an aspect includes a plurality of stacked units each including a high-refractive layer and a low-refractive layer and includes “Ge” in an amount of about 10 at % to about 50 at % in the high-refractive layer in each of the stacked units, and thus strong hardness properties and excellent reflection reduction properties may be exhibited at the same time. Therefore, the optical member according to an aspect may function as a low reflection member that has excellent scratch resistance and excellent anti-reflection performance.

The cover window according to an aspect includes an optical member that includes a plurality of stacked units, each including a high-refractive layer and a low-refractive layer and including “Ge” in an amount of about 10 at % to about 50 at % in the high-refractive layer, and thus high-hardness and excellent optical properties may be exhibited at the same time.

In the electronic apparatus according to an aspect, the cover window disposed on the display module may include an optical member that includes a plurality of stacked units, each including a high-refractive layer and a low-refractive layer, and includes “Ge” in an amount of about 10 at % to about 50 at % in the high-refractive layer in each stacked unit, and thus excellent reliability due to high-strength properties may be exhibited.

The optical member according to an aspect includes a plurality of stacked units, each including a high-refractive layer and a low-refractive layer, wherein materials for the high-refractive layer and the low-refractive layer are optimized in each of the stacked units, and thus high strength and excellent reflection reduction properties may be exhibited.

The cover window according to an aspect includes the optical member, disposed on a base substrate and including a plurality of stacked units, each including a high-refractive layer and a low-refractive layer, wherein the materials for the high-refractive layer and low-refractive layer are optimized in each of the stacked units. Therefore, the cover window according to an aspect may exhibit excellent surface strength and improved optical properties.

The electronic apparatus according to includes the optical member including a plurality of stacked units, each including a high-refractive layer and a low-refractive layer, wherein the materials for the high-refractive layer and the low-refractive layer are optimized in each of the stacked units, and thus excellent strength and improved display quality may be exhibited.

Hitherto, although the aspects of the present disclosure have been described with reference to preferable aspects, and those skilled in the art or having ordinary knowledge of the art will understand that various modifications and changes can be made without departing from the technical idea or features of the present disclosure.

Accordingly, the technical scope of the present disclosure is not limited to what is set forth in the detailed description of the specification.

What is claimed is:

1. An optical member comprising a plurality of stacked units,
each stacked unit comprising a high-refractive layer and a low-refractive layer directly disposed on the high-refractive layer, the low-refractive layer having a refractive index at least about 0.3 lower than a refractive index of the high-refractive layer,
wherein the high-refractive layer includes a composite material comprising Ge, and a content of the Ge in the composite material is about 10 at % to about 50 at %.

2. The optical member of claim 1, wherein the high-refractive layer of each stacked unit comprises at least one among a Ge₃N₄ composite material, an Al—Ge—N composite material, or an Al—Ge—O—N composite material.

3. The optical member of claim 2, wherein the low-refractive layer of each stacked unit comprises at least one among SiO₂, SiON, or SiCₓHO_{y}N_{z}.

4. The optical member of claim 3,
wherein all the high-refractive layers in the plurality of stacked units comprise an Al—Ge—N composite material, and
all the low-refractive layers in the plurality of stacked units comprise an SiCₓO_{y}N_{z} composite material.

5. The optical member of claim 3,
wherein the high-refractive layer of each stacked unit has a refractive index of about 1.90 to about 2.30 at about 550 nm, and
the low-refractive layer of each stacked unit has a refractive index of about 1.40 to about 1.60 at about 550 nm.

6. The optical member of claim 1, further comprising a base low-refractive layer disposed below a lowest stacked unit among the plurality of stacked units,
wherein the base low-refractive layer comprises at least one among SiO₂, SiON, or SiCₓO_{y}N_{z}.

7. The optical member of claim 1,
wherein the plurality of stacked units comprises a first to a sixth stacked units, sequentially stacked in a thickness direction of the optical member, and
the optical member further comprises a base low-refractive layer disposed below the first stacked unit,
wherein the high-refractive layer of each of the first to the sixth stacked units comprises an Al—Ge—N composite material, and
the low-refractive layers of the first to the sixth stacked units and the base low-refractive layer each independently comprise SiO₂ or SiCₓO_{y}N_{z}, and at least one among the low-refractive layers of the first to the sixth stacked units comprises SiCₓO_{y}N_{z}.

8. The optical member of claim 1, further comprising an anti-fingerprint layer, disposed directly on an uppermost stacked unit among the plurality of stacked units, the anti-fingerprint layer having a thickness of about 10 nm to about 30 nm.

9. A cover window comprising:
a base substrate; and
an optical member disposed on the base substrate, the optical member including a plurality of stacked units,
wherein each stacked unit of the plurality of stacked units includes a high-refractive layer, and a low-refractive layer disposed directly on the high-refractive layer, the low-refractive layer having a refractive index at least about 0.3 lower than a refractive index of the high-refractive layer, and
the high-refractive layer comprises a composite material including Ge, and a content of Ge in the composite material is about 10 at % to about 50 at %.

10. The cover window of claim 9,
wherein the high-refractive layer of each stacked unit comprises at least one among a Ge₃N₄ composite material, an Al—Ge—N composite material, or an Al—Ge—O—N composite material, and
the low-refractive layer of each stacked unit comprises at least one among SiO₂, SiON, or SiCₓO_{y}N_{z}.

11. The cover window of claim 9,
wherein the plurality of stacked units comprises a first to a sixth stacked units, sequentially stacked in a thickness direction of the optical member, and
the optical member further comprises a base low-refractive layer directly disposed between the base substrate and the first stacked unit,
wherein the high-refractive layer of each of the first to the sixth stacked units includes an Al—Ge—N composite material, and
the low-refractive layers of the first to the sixth stacked units and the base low-refractive layer each independently comprise SiO₂ or SiCₓO_{y}N_{z}, and at least one among the low-refractive layers of the first to the sixth stacked units comprises SiCₓHO_{y}N_{z}.

12. The cover window of claim 9,
wherein a refractive index of each high-refractive layer is about 1.90 to about 2.30 at about 550 nm, and
a refractive index of each low-refractive layer is about 1.40 to about 1.60 at about 550 nm.

13. The cover window of claim 9, wherein the cover window has a hardness at an indentation depth of about 100 nm or less, as measured by a nano indenter, of about 15 GPa or more.

14. The cover window of claim 9, wherein the cover window has a maximum hardness according to an indentation depth, as measured by the nano indenter, of about 20 GPa or more.

15. The cover window of claim 13, wherein the cover window has an average SCI reflectance of about 0.4% or less.

16. An electronic apparatus comprising:
a display module configured to generate an image; and
a cover window disposed on the display module,
wherein the cover window comprises:
a base substrate; and
an optical member disposed on the base substrate, the optical member including a plurality of stacked units,
wherein each stacked unit of the plurality of stacked units includes a high-refractive layer, and a low-refractive layer disposed directly on the high-refractive layer, the low-refractive layer having a refractive index at least about 0.3 lower than a refractive index of the high-refractive layer, and
the high-refractive layer comprises a composite material including Ge, and a content of Ge in the composite material is about 10 at % to about 50 at %.

17. The electronic apparatus of claim 16,
wherein the high-refractive layer of each stacked unit comprises at least one among a Ge₃N₄ composite material, an Al—Ge—N composite material, or an Al—Ge—O—N composite material, and
the low-refractive layer of each stacked unit comprises at least one among SiO₂, SiON, or SiCₓO_{y}N_{z}.

18. The electronic apparatus of claim 17,
wherein the plurality of stacked units comprises a first to a sixth stacked units, sequentially stacked in a thickness direction of the optical member, and
the optical member further comprises a base low-refractive layer directly disposed between the base substrate and the first stacked unit,
wherein the high-refractive layer of each of the first to the sixth stacked units includes an Al—Ge—N composite material, and
the low-refractive layers of the first to the sixth stacked units and the base low-refractive layer each independently comprise SiO₂ or SiCₓO_{y}N_{z}, and at least one among the low-refractive layers of the first to the sixth stacked units comprises SiCₓO_{y}N_{z}.

19. The electronic apparatus of claim 16, wherein the cover window has a hardness of about 15 GPa or greater at an indentation depth of about 100 nm or less, as measured by a nano indenter, and an average SCI reflectance of about 5% or less.

20. The electronic apparatus of claim 16, further comprising at least one among a power module, a processor, or a memory.
